(19) United States
(12) Patent Application Publication
(10) Pub. No.: US 2020/0331398 A1
(43) Pub. Date: Oct. 22, 2020

(54) Bicycle Transport Components and Bicycle Carriers for Vehicles

(71) Applicant: Jeffrey V. Bamber, Cincinnati, OH (US)

(72) Inventor: Jeffrey V. Bamber, Cincinnati, OH (US)

(21) Appl. No.: 16/805,543

(22) Filed: Feb. 28, 2020

Related U.S. Application Data
(60) Provisional application No. 62/812,940, filed on Mar. 1, 2019.

(51) Int. Cl. B60R 5/04

(52) U.S. Cl. CPC B60R 5/04; B60R 2011/0082

(57) ABSTRACT

Article transport components, particularly wheeled article transport components such as bicycle transport components, bicycle carriers, and bicycle carrier systems for transporting bicycles inside vehicles are disclosed. The bicycle transport components may be in the form of at least one transport component that comes into contact with at least some of the portions of a bicycle that would otherwise contact a surface when a bicycle is placed on its side. The transport component has a contact surface with a lower coefficient of friction that permits the transport component with a bicycle thereon to be slid along the inside surface of a vehicle. In other cases, the bicycle carriers may include a combination, or assembly of components that provide a system for transporting two or more bicycles in the interior of a vehicle. Methods of transporting bicycles in a vehicle are also disclosed.

### FIELD OF THE INVENTION

The present invention relates to article transport components, particularly wheeled article transport components such as bicycle transport components, bicycle carriers, and bicycle carrier systems, and more particularly to bicycle transport components, bicycle carriers, and bicycle carrier systems that can be used to transport bicycles inside a vehicle.

### BACKGROUND OF THE INVENTION

Numerous different types of bicycle carriers for vehicles are currently on the market. Some bicycle carriers are designed to be fastened to the back of vehicles. Others are designed to be fastened to a vehicle's trailer hitch. Still others are designed to be fastened to a rack on a vehicle's roof.

Patents relating to bicycle carriers for vehicles include U.S. Pat. No. 9,783,120 B2, Lungershausen, et al (GM Global Technology Operations LLC); U.S. Pat. No. 9,908,478 B2. Leff Yaffe, et al. (Ford Global Technologies), and the references listed on the face and any subsequent pages thereof.

Other types of products are designed to carry objects in vehicles. U.S. Pat. No. 9,132,786 B2, Roach is directed to a collapsible automotive storage container. A utility tray assembly for mounting in a vehicle for tools, equipment, and firearms is described in U.S. Pat. No. 10,137,839 B1, Kelley. Jr.

Current bicycle carriers may suffer from various disadvantages, depending on the type of carrier. Bicycle carriers that carry bicycles outside of vehicles allow the bicycles thereon to be subject to the outside weather conditions (rain, and the like). Bicycles that are carried outside of vehicles, and the carriers for the same, can also be stolen or vandalized. Thus, it may not be desirable for a bicyclist who wants to ride later in the day to drive to work with a bicycle on an externally mounted bicycle carrier.

External trailer hitch-mounted bicycle carriers may further be undesirable because they require the installation of a trailer hitch, which can be expensive. External roof rack bicycle carriers require that the bicycle(s) be lifted up and placed on the roof of a vehicle. Many people do not have the strength to lift bicycles up to such roof racks.

Bicycle carriers that currently store bicycles inside vehicles often require the bicycle owner to take apart various portions of the bicycles (such as a wheel, and/or seat) in order to fit the bicycle(s) inside their vehicle. Some of such carriers need to be fastened or bolted to the inside of the vehicle. As a result, some of such interior mounted bicycle carriers may not be easily removable when the vehicle owner wants to use the trunk or storage space for other purposes.

Sliding bicycle carriers for storing bicycles inside vehicles have also been proposed. A website faroutride.com/slide-out-bike-rack shows a FORD® TRANSIT® van with homemade built-in slide out drawer-like trays in the rear cargo area for bicycles to be placed upon in an upright condition with the front wheels removed. A website priuschat.com shows a stand and a sliding tray for assisting with lifting and inserting two electric bicycles laid on their sides in the back of a HONDA® PRIUS® hatchback car. The former carrier may interfere with other uses of the storage space of the vehicle when bicycles are not being transported. The sliding tray in the PRIUS® car; also requires removal of the front wheels of the bicycles; does not disclose any mechanism for attaching the bicycles to the tray; does not disclose any way of separating the bicycles for protecting the same when one is laid on top of another; and, requires a separate stand for loading the bicycles onto the tray.

Thus, there is a need for bicycle carriers that ensure that the bicycles and the carrier are both secure inside the vehicle. There is a need for bicycle carriers that do not require that the vehicle have a trailer hitch. There is a need for bicycle carriers that do not require the bicycle(s) to be lifted up onto the roof of a vehicle. There is a need for bicycle carriers that do not require that components of the bicycle carrier be bolted into the inside of the vehicle. There is a need for bicycle carriers that do not require the bicycle to be taken apart in order to place the bicycle(s) inside the vehicle. There is a need for bicycle carriers that are easily removable from the vehicle when the vehicle owner wants to use the trunk/storage space for other things.

### SUMMARY OF THE INVENTION

The present invention relates to article transport components, particularly wheeled article transport components such as bicycle transport components, bicycle carriers, and bicycle carrier systems, and more particularly to bicycle transport components, bicycle carriers, and bicycle carrier systems that can be used to transport articles, such as bicycles inside a vehicle.

The bicycle transport components comprise an article of manufacture that may be placed adjacent a part of a bicycle (or have at least a part of a bicycle placed thereon) to assist in sliding a bicycle along the inside surface of a vehicle. The bicycle transport component(s) can be provided in a number of different forms. There may be a single bicycle transport component that is configured to be placed adjacent to one or more parts of a bicycle that would otherwise come into contact with the inside surface of a vehicle. In some cases, the single bicycle transport component may be large enough that it is used to support and carry a bicycle. Such a bicycle transport component may be referred to as a bicycle carrier. In other cases, a plurality of bicycle transport components (or set of bicycle transport components) can be used for a given bicycle, where each bicycle transport component is configured to be placed adjacent to one or more different parts of the bicycle.

The bicycle transport components and bicycle carriers described herein may comprise one or more parts. The bicycle transport components typically comprise a member, at least a portion of which is substantially rigid, which member has a first side and an opposed second side. At least part of the first side is configured to directly or indirectly contact a part of a bicycle that would otherwise contact the inside surface of a vehicle when a bicycle is laid on its side. The second side is for placing onto the inside surface of a vehicle. The second side comprises a contact surface that permits the transport component with a bicycle thereon to be slid along the inside surface of a vehicle more easily than the bicycle can be slid without the bicycle transport component. In some cases, the bicycle can be placed on top of a bicycle transport component without fastening the bicycle to the bicycle transport component. In other cases, the bicycle transport component can be provided with a fastener that is used either to fasten the bicycle transport component to a bicycle; or to fasten the bicycle to the bicycle transport component.

In some cases, the bicycle transport component(s) may be configured to only assist with sliding the bicycle on the inside surface of a vehicle. In other cases, the bicycle transport component can be configured to assist with lifting a bicycle and/or positioning a bicycle inside a vehicle and removing a bicycle from a vehicle.

In some cases, the bicycle transport component(s) and/or the bicycle carrier(s) may comprise a group of components that comprise a bicycle carrier system for transporting two or more bicycles in the interior of a vehicle. In some cases, any of the types of bicycle transport component(s) described above may comprise a first bicycle transport component (or first set of bicycle transport components) for a first bicycle. Any of the types of bicycle transport component(s) described above may comprise a second bicycle transport component (or second set of bicycle transport components) for a second bicycle. Of course, there can also be third, fourth, etc. bicycle transport components or sets of bicycle transport components. The first bicycle transport component (or first set of bicycle transport components) may either be of the same type, or of a different type, from the second, third. etc. bicycle transport component (or second, third, etc. set of bicycle transport components). The system may further comprise a supporting component for supporting a second bicycle and its transport component(s) above the first bicycle. The supporting component may comprise an article of manufacture having a surface on which the second bicycle and its transport component(s) may be placed. The supporting component may be in the nature of a shelf, or a stand that is disposed above the first bicycle.

A method of transporting a bicycle in a vehicle is also disclosed herein. The method may comprise the steps of:

a) providing a transport component comprising a member, at least a portion of which is substantially rigid, which member has a first side and a second side, wherein at least part of the first side is configured to contact a portion of a bicycle that would otherwise contact a surface when a bicycle a laid on its side, and a second side that may be placed onto the inside surface of a vehicle, wherein said second side comprises a contact surface that permits said transport component with a bicycle thereon to be slid on the inside surface of a vehicle:

b) bringing said transport component and a bicycle adjacent to one another by either placing said transport component on at least part of the bicycle, or by placing the bicycle on said transport component:

c) lifting the bicycle with the transport component adjacent thereto so that the bicycle and transport component are at least partially positioned in the trunk or storage space of a vehicle with the contact surface of the member adjacent the inside surface of the trunk or storage space of a vehicle; and

d) sliding the bicycle with the transport component adjacent thereto so that it is positioned entirely within the trunk or storage space of a vehicle.

To transport two or more bicycles in a vehicle, the method may further comprise the steps of:

e) providing a supporting component having a platform configured to support a second bicycle in the trunk or storage space of the vehicle;

t) positioning said supporting component in the trunk or storage space of the vehicle so that said platform is above at least a portion of the bicycle, said bicycle being the first bicycle:

g) providing a second transport component comprising a member, at least a portion of which is substantially rigid, which member has a first side and a second side, wherein at least part of the first side is configured to contact a portion of a bicycle that would otherwise contact a surface when a bicycle a laid on its side, and a second side that may be placed onto the inside surface of a vehicle, wherein said second side forms a contact surface that permits said second transport component with a bicycle thereon to be slid inside a vehicle:

h) bringing said second transport component and a second bicycle adjacent to one another by either placing said second transport component on at least part of the second bicycle, or by placing the second bicycle on said second transport component;

i) lifting the second bicycle with the second transport component adjacent thereto so that it is at least partially in the trunk or storage space of a vehicle and at least partially resting on the platform of the supporting component; and

j) sliding the second bicycle with the second transport component adjacent thereto onto said platform so that the second bicycle with the second transport component adjacent thereto is positioned entirely within the trunk or storage space of a vehicle.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention. Any of the embodiments described herein can also be combined with any other embodiments in any manner to form still other embodiments.

### BRIEF DESCRIPTION OF THE DRAWINGS

While the specification concludes with claims particularly pointing out and distinctly claiming the present invention, it is believed the invention will be better understood from the following description taken in conjunction with the accompanying drawings.

FIG. 1 is a plan view of one embodiment of a transport component for a bicycle shown with the bicycle lying on its side on top of the transport component.

FIG. 2 is a plan view of another embodiment of a transport component for a bicycle shown with the bicycle lying on its side on top of the transport component.

FIG. 3 is a plan view of another embodiment of a transport component for a bicycle shown with the bicycle lying on its side on top of the transport component.

FIG. 4 is a plan view of another embodiment of a transport component for a bicycle shown with the bicycle lying on its side on top of the transport component.

FIG. 5 is a fragmented perspective view of the member of a transport component that has a second side with a convex curvature.

FIG. 6 is an end view of the member of a transport component that has a second side with a convex curvature and elevated sliders thereon.

FIG. 7 is a plan view of another embodiment in which there are multiple transport components for a bicycle shown with the bicycle lying on its side on top of the transport components.

FIG. 8 is a perspective view of a wheel transport component.

FIG. 9 is a perspective view of a hub transport component.

FIG. 10 is a perspective view of a pedal transport component.

FIG. 11 is a fragmented side view of a vehicle with a transport component partially inserted into the rear storage area of the vehicle.

FIG. 12 is a fragmented side view of a vehicle with a transport component with a bicycle thereon partially inserted into the rear storage area of the vehicle.

FIG. 13 is a fragmented side view of a vehicle with a transport component with a bicycle thereon more fully inserted into the rear storage area of the vehicle.

FIG. 14 is a fragmented side view of a vehicle and a bicycle lying on its side on a transport component resting on the ground behind the vehicle.

FIG. 15 is a fragmented side view of a vehicle and a bicycle lying on its side on a transport component with one end of the transport component lifted to rest on the back of the storage area of the vehicle.

FIG. 16 is a fragmented side view of a vehicle and a bicycle lying on its side on a transport component that has been lifted and partially inserted into the back of the storage area of the vehicle.

FIG. 17 is a side view of a transport component having a bungee cord and deployable legs to prevent the transport component from sliding after it is in the desired position inside a vehicle.

FIG. 18 is a fragmented perspective view of the rear of a vehicle with its trunk door open showing one example of a bicycle carrier system.

FIG. 19 is an end view of the bicycle carrier system shown in FIG. 18.

FIG. 20 is a top view of the bicycle carrier system shown in FIG. 18.

FIG. 21 is a side view of the bicycle carrier system shown in FIG. 18.

FIG. 22 is a plan view of alternative supporting component having a wire rack structure and an I-shaped platform.

FIG. 23 is a side view of a supporting component having telescoping legs and legs which are repositionable along the length of the platform.

FIG. 24 is an end view of a supporting component which is foldable and has foldable legs.

FIG. 25 is an end view of the supporting component shown in FIG. 24 after the legs have been folded.

FIG. 26 is an end view of the supporting component shown in FIG. 25 after the platform has been folded.

FIG. 27 is a fragmented perspective view of the rear of a vehicle with its trunk door open showing an example of a supporting component in the form of a shelf, or horizontally-oriented trunk divider that may be configured to fit a particular model of vehicle.

FIG. 28 is a plan view of one embodiment of a transport component for a patient transport chair shown with the transport chair lying on its side on top of the transport component.

### DETAILED DESCRIPTION OF THE INVENTION

The present invention relates to article transport components, particularly wheeled article transport components such as bicycle transport components, bicycle carriers, and bicycle carrier systems, and more particularly to bicycle transport components, bicycle carriers, and bicycle carrier systems that can be used to transport bicycles inside a vehicle.

The bicycle transport components, bicycle carriers, and bicycle carrier systems can be used with any type of vehicle that has space for a bicycle to be stored in the vehicle's interior space. Suitable types of vehicles include, but are not limited to: sport utility vehicles (SUVs), minivans, crossovers, station wagons, pickup trucks, and cars. The bicycle transport components, bicycle carriers, and bicycle carrier systems are, thus, well-suited for use with vehicles having a rear door or hatch back. In some cars, it may, however, be necessary to remove part of the bicycle (such as the front wheel), depending on the size of the car.

The term “bicycle transport components)”, as used herein, refers to one or more articles of manufacture that may be placed adjacent a part of a bicycle (or have at least a part of a bicycle placed thereon) to assist in sliding a bicycle along the inside surface of a vehicle. Any of the various transport components described herein may be referred to in the alternative as “sliders”.

The term “bicycle carrier”, as used herein, refers to a bicycle transport component that is large enough that it can be used to support and carry a bicycle.

The term “bicycle carrier system”, as used herein, refers to one or more bicycle transport components and/or one or more bicycle carriers, and at least one supporting component.

The term “joined”, as used herein, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element. i.e., one element is essentially part of the other element. The term “joined” includes both those configurations in which an element is temporarily joined to another element, or in which an element is permanently joined to another element.

The bicycle transport component(s) can be provided in a number of different forms. There may be a single bicycle transport component that is configured to be placed adjacent to one or more parts of a bicycle that would otherwise come into contact with the inside surface of a vehicle. In some cases, the single bicycle transport component may be large enough that it is used to support and carry a bicycle. Such a bicycle transport component may be referred to as a bicycle carrier. In other cases, a plurality of bicycle transport components (or set of bicycle transport components) can be used for a given bicycle, where each bicycle transport component is configured to be placed adjacent to one or more different parts of the bicycle.

The bicycle transport components and bicycle carriers described herein may comprise one or more parts. The bicycle transport components typically comprise a member, at least a portion of which is substantially rigid, which member (or “member”) has a first side and an opposed second side. If all, or the largest portion of the member is substantially rigid, the member may be referred to herein as a “substantially rigid member”. At least part of the first side is configured to directly or indirectly contact (that is, to at least indirectly contact) part of a bicycle that would otherwise contact the inside surface of a vehicle when a bicycle is laid on its side. The first side of the member may indirectly contact a part of a bicycle when there is a molded element, padding, or other material between the part of the bicycle and the first side of the member. The second side is for placing onto the inside surface of a vehicle. The second side comprises a contact surface that permits the transport component with a bicycle thereon to be slid along the inside surface of a vehicle more easily than the bicycle can be slid without the bicycle transport component.

In some cases, it may be said that the bicycle transport component(s) “cover” a part of a bicycle. When it is said that the bicycle transport component(s) “cover” a part of a bicycle, this means that the transport component(s) is/are configured so that they are positioned between (i.e., underlie) the specified part of the bicycle and the surface of the vehicle, such as surface of the trunk or storage space of a vehicle so as to eliminate direct contact between the part of the bicycle and the surface of the trunk or storage space of a vehicle. Complete enclosure of the part of the bicycle is not required.

FIG. 1 shows one non-limiting example of a transport component 20 with a bicycle 10 thereon. The transport component 20 comprises a member 22, which comprises at least the portion (or portions) of the transport component 20 that will cover or underlie the relevant part or parts of a bicycle 10. In this example, the member 22 may also function as a holder for the bicycle (or bicycle carrier). Such a member 22 may, therefore, alternatively be referred to as a “holder”. If it is only necessary to transport one bicycle in the vehicle, such a transport component 20 may comprise the entire bicycle carrier. The member 22 has a first side 22A and an opposed second side 22B. In the embodiment shown, the member 22 has a pair of longitudinal sides 22C (which may terminate at side edges) and opposing ends 22D and 22E (which may terminate at end edges).

FIG. 1 shows that, in some cases, the member 22 may comprise the only component part of the transport component 20. Therefore, in such cases, the transport component 20 and the member 22 may be considered to be one and the same. In such cases, the first surface and second surface of the transport component will be the same as the respective first side 22A and second side 22B of the member 22. In other embodiments (as described below), the transport component 20 may comprise other elements or component parts. The member 22 may be, and often is, removable and free from attachment to the vehicle in which the bicycle will be transported (unlike a drawer, tray, or other structure which is joined to a vehicle and which may require tools to remove).

The transport component 20 (and member 22) may have any suitable properties. In this description, it is understood that when the member 22 is described as having certain properties, at least a portion of the transport component 20 may have the same properties (since the member 22 comprises at least a portion of the transport component 20). In some cases, the member 22 may comprise at least some portions that are at least substantially rigid. Thus, it may be desirable that the member 22 is not drapable (that is, the member 22 may be “non-drapable”) across its surface and, thus, be unlike a sheet or blanket. In some cases, the entire member 22 may be at least substantially rigid. The term “substantially rigid”, as used herein, means that the member 22 may flex, but does not bend undesirably (or have portions which fold or flop about an axis) when the transport component 20 is used as described herein. Thus, the portions of the member 22 (or all, of the member) described herein can be said to have flexural rigidity. Examples of articles with suitable flexural rigidity for the transport component (and member) can include plastic (polypropylene) lids for heavy duty storage totes and plastic sleds. The member 22 may also be lexurally resilient so that after the flexural forces are removed, it returns substantially, or completely, to its original configuration. Thus, the member 22 may be said to be resistant to, or avoids, permanent bending of the member 22′ when it is used to transport and slide a bicycle thereon. In these or other cases, the member 22 may be rigid such that it does not flex at all under the forces associated with using the same.

The member 22 may be relatively thin and light. The member 22 may, for example, have a thickness of less than or equal to: 0.5, 0.45, 0.4, 0.35, 0.3, 0.25, 0.2, 0.15, or 0.1 inches. When the thickness of the member 22 is specified herein, the thickness of any padding for protecting the bicycle that is joined to the member 22 is excluded from the measurement. The member 22, in some cases, may have a uniform thickness, or a substantially uniform thickness (such that any variations are less than or equal to about 0.15, 01, or less inches), over the entirety of its area within its periphery. The member 22 may comprise a planar piece of material. However, it is also possible that the member be formed of a planar piece of material that may be bent in various places such as to form a wall around at least a portion of its periphery and/or to form at least a portion of the same into a structure which is convex on one surface and concave on the opposing surface, or to provide raised runners, or the like on its second side 22. The weight of the member 22 will depend on the size and type of the transport component 20, which transport component types are described in greater detail herein. In the case of a transport component 20 that also serves as bicycle carrier where the member underlies substantially all of a bicycle, the member may weigh as much as 5 lb., or more, but for ease in handling, it may weigh less than or equal to: 5, 4, 3, or 2 lbs. In the case of transport components 20 that are sized and configured to underlie less than substantially all of a bicycle, the member may weigh less than or equal to 5, 4, 3, 2, 1, or 0.5 lbs., or less. (The phrase “sized and configured”, as used herein, means larger in all dimensions than the surface-contacting part(s) of a bicycle or other article that the member is intended to underlie.) In addition, if the transport component 20 is sized and configured to underlie two or fewer of the surface-contacting parts of a bicycle, the member may weigh less than or equal to: 15, 14, 13, 12, 1, 10, 9, 8, 7, 6, 5, 4, 3, 2, or 1 ounce.

The bicycle 10 may be of any known type (and is not part of the claimed invention unless specifically indicated in the claims as being part of a “combination” including a bicycle). The bicycle 10 has the following parts: a frame 30, a (front) fork 32, a pair of wheels 34 and 36, handle bars 38, front brakes 40, rear brakes 42, a seat 44, pedals 46, and a chain 48. The frame 30 comprises a top tube 50, a head tube 52, a seat tube 54, a downtube 56, a pair of seat stays 58, and a pair of chain stays 60. The frame 30 and fork 32 together form the frameset of the bicycle. The wheels 34 and 36 each comprise a wheel portion 62 and a tire 64. The wheel portions 62 comprise a hub 66 that includes an axle often terminating in threaded extensions 68, a plurality of spokes 70, and a rim 72. The pedals 46 extend from a bottom bracket 74, and are attached to a chain ring 76. A crank arm 78 extends from the bottom bracket 74 axle to each of the pedals 46. Many bicycles also have a gear drive system that includes a front derailleur 80 and a rear derailleur 82.

When a bicycle 10 is laid on its side on a surface, such as the inside surface of a vehicle, there are typically a limited number of parts of the bicycle that will come into contact with such a surface. These “surface-contacting parts” of a bicycle may include: the portions of the side walls and bottoms of the tires along the lower portions of the tires 64 (which may be referred to as the “lower portions” of the tires); the end of the rear axle or hub 66 of the bicycle that is closest to the surface; the pedal 46 that is closest to the surface; possibly the end of the front axle or hub 66 of the bicycle that is closest to the surface; and the handle bar 38 that is closest to the surface. The term “ends of the axles” (or “ends of the hubs”) will include situations in which there are threaded extensions 68, situations in which there are no extensions 68, as well as situations in which there are quick release mechanisms for removing the wheels at the ends of the axle or hub 66 of the bicycle. It should be noted that, when laying a bicycle on its side, it ma % be desirable to lay the bicycle with its side drive side up to avoid having the derailleurs present, if any, from becoming misaligned.

The transport component 20 can underlie the entire bicycle 10 or only part of the bicycle when a bicycle is laid on its side. FIGS. 1-4 show several non-limiting examples of transport components 20 that may underlie various portions of a bicycle 10.

FIG. 1 shows an example of a transport component 20 that underlies nearly all of a bicycle 10. The only parts of the bicycle that the transport component 20 does not underlie are the front portion of the front wheel 34, and the rear portion of the rear wheel 36. In other cases, the transport component 20 also need not underlie the seat 44. In such an embodiment, the transport component 20 may be elongate, generally rectangular (e.g., optionally with rounded corners), and substantially planar. The transport component 20 could, of course, be made into a larger rectangular shape (or made into a different shape) so that the transport component 20 would also underlie some or all of these parts of the bicycle (e.g., the front and rear portions of the wheels and the seat). Since these parts of the bicycle 10 will typically not contact the inside of a vehicle when the bicycle is lying on its side, it is not necessary that the transport component 20 underlie these parts of the bicycle for the purposes of sliding the bicycle inside the vehicle. However, for loading the bicycle into the vehicle, such as in the manner shown in FIGS. 14-16, it may, for example, be useful to have the transport component underlie the trailing end of the wheel and tire that are loaded into the vehicle last so that this portion will not contact the ground and exert sliding forces between the bicycle and the transport component 20.

The transport component 20 (and member 22) may be of any suitable size depending on the embodiment and the opening and size of the storage space of the vehicle being used to transport the bicycle(s). An average adult bicycle may be about 68 inches long including the wheels. If the transport component 20 is of the type shown in FIG. 1, the member 20 can have a length of up to 75 inches or more and a width of up to 45 inches or more. (Of course, any of the dimensions specified herein may be less for children's bicycles; and, any of the dimensions specified herein may be expressed in terms of the area of the members by multiplying length by width or calculating the area of a circular member using its diameter.)

In some cases, it may be advantageous for the transport component 20 to be made as small as possible while still carrying out its function of covering at least some of the part or parts of a bicycle that would otherwise come into contact with the surface of the trunk or storage space of a vehicle when the bicycle is laid on its side and slid into the trunk or storage space. The transport component 20 can still provide such a benefit to a certain degree, even if it covers fewer than all of the parts of a bicycle that would otherwise come into contact with the surface of the trunk or storage space of a vehicle when the bicycle is laid on its side. Making the transport component 20 smaller will reduce the weight of the same so that it will be easier to lift the bicycle 10 and transport component 20. It may also allow the dimensions of the supporting component 140 described in greater detail below to be reduced.

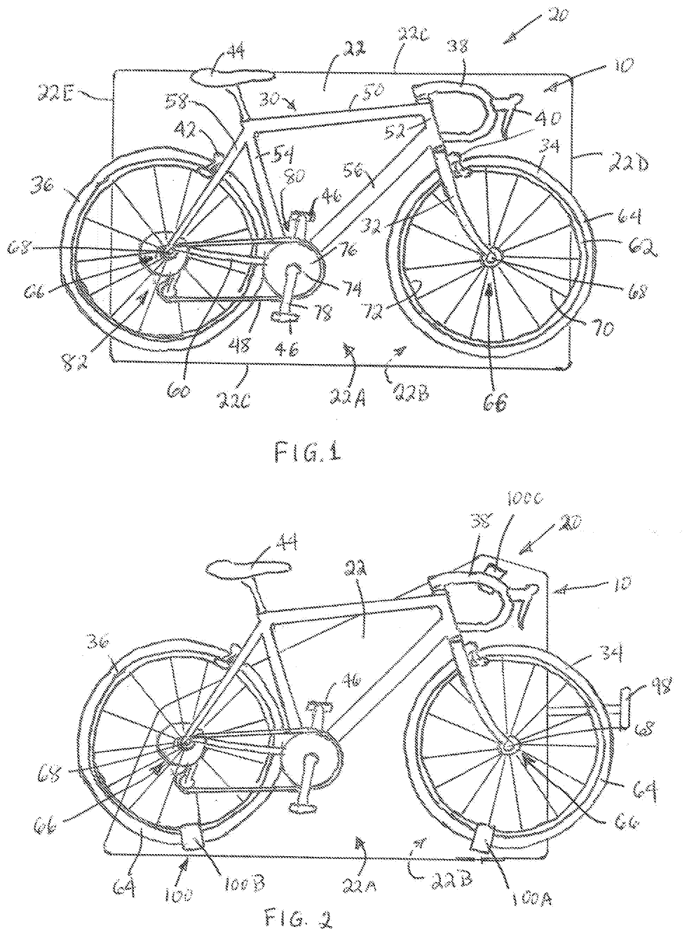

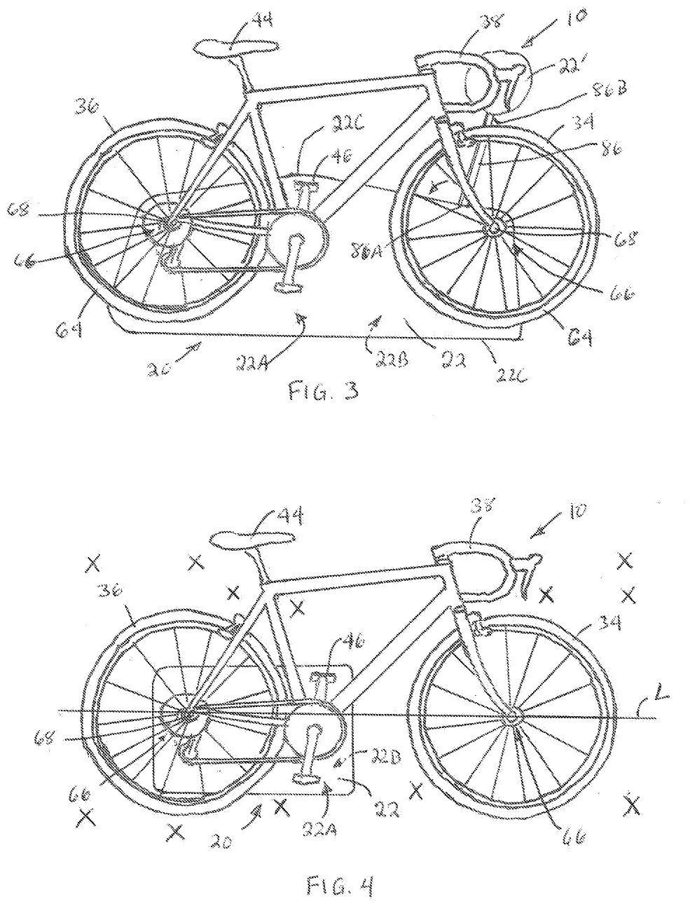

FIGS. 2-4 show several non-limiting examples of such smaller transport components 20. The examples of the transport components in FIGS. 2-4 each cover at least two of the surface-contacting parts of a bicycle. These figures show that, in some cases, the transport component 20 may be sized and configured to span at least from the lowermost pedal 46 of a bicycle laid on its side to at least one of the axles/hubs 66 of the bicycle. (in other cases, as shown in FIGS. 4 and 7, separate transport components can be provided that are each sized and configured to cover or underlie two or fewer (that is, only one or two) of the surface-contacting parts of a bicycle. When it is said that a transport component underlies only certain surface-contacting parts of a bicycle, in some cases this may mean that the periphery of the member 22 may not extend beyond the specified surface-contacting parts of a bicycle by more than a certain distance (e.g., 1, 2, 3, 4, 5, or 6 inches).

FIG. 2 shows an example of a transport component 20 comprising a member 22 that underlies the lower portions of the tires 64, the end of the rear axle or hub 66 of the bicycle 10 that is closest to the surface, the pedal 46 that is closest to the surface, the handle bar 38 that is closest to the surface, and the end of the front axle or hub 66 of the bicycle 10 that is closest to the surface. This transport component 20 can, thus, be considered to be sized and configured to span from the rear axle/hub 66 of the bicycle past the pedal 46 portion of the bicycle, and all the way to the front axle/hub 66 of the bicycle. Since bicycle wheels are often 26 to 29 inches in diameter, in the embodiment shown in FIG. 2, it may be desirable for the width of the narrower portion covering the bottom of the rear wheel and hub 66 to be greater than half of the diameter of the wheel, but less than the full diameter of the wheel. Therefore, the width of this portion of the member 22 may, for instance, be between about 14, 15, or 16 inches and about 25, 26, or 27 inches. In some cases, the width may terminate closer to the axle than the top portion of the wheel.

FIG. 3 shows an example of a transport component 20 that underlies the lower portions of the tires 64, the end of the rear axle or hub 66 of the bicycle 10 that is closest to the surface, the pedal 46 that is closest to the surface, the end of the front axle or hub 66 of the bicycle that is closest to the surface, but not the handle bars 38. In such an embodiment, the transport component 20 is sized and configured to cover or underlie three or fewer of the surface-contacting parts of a bicycle. In such an embodiment, the user can slide the bicycle 10 and transport component 20 into the vehicle while holding the handle bars so that the handle bars 38 make minimal contact with the inside surface of the vehicle.

In the embodiment shown in FIG. 3, it may be desirable for the member 22 to have a length that is greater than distance between the two axles (the wheelbase) and a width that is greater than the distance from the bottom of the tires to the top of the pedal 46. In some cases, the wheelbase of a bicycle may be about 41.5 inches. The length of the member 22 may, for example, be between about 42, or more inches and about 50 to 65 or more inches, and the width of the member 22 may be the same as that specified for the narrow portion in FIG. 2. One suitable size of the member 22 of the embodiments shown in FIG. 3 may be about 65 inches long and about 22 inches wide.

In a variation of this embodiment as shown in FIG. 3, the transport component 20 can be provided with an optional arm 86 having a proximal end 86A joined to the member 22 and a distal end 86B that extends toward the handlebars 38. The distal end 86B of the arm 86 is joined to a second member 22′ that underlies the portion of the handlebars that would otherwise contact the surface of the vehicle. The second member 22′ can have any of the properties described herein for the member 22. The arm 86 can be made of any suitable material including but not limited to metal (such as aluminum) and/or have an L-shaped (or other suitable shape) cross-section for greater rigidity than the member 22. The arm 86 can be foldable such as in the direction of the arrow to a position alongside the longitudinal edge 22C of the member 22 for storage.

FIG. 4 shows an example of a transport component 20 that only underlies the end of the rear axle or hub 66 of the bicycle 10 that is closest to the surface and the pedal 46 that is closest to the surface. This transport component 20 is sized and configured to span only from the rear axle or hub 66 of the bicycle to the pedal portion of the bicycle. In such an embodiment, the user can slide the bicycle 10 and transport component 20 into the vehicle while holding the front wheel 34 and the handle bars 38 so that the front wheel 34 and handle bars 38 make minimal contact with the inside surface of the vehicle. In the embodiment shown in FIG. 4, it may be desirable for the member 22 to have a length that is greater than distance between the chain ring and rear derailleur and a width that is greater than the distance from the bottom of one pedal 46 to the top of the other pedal 46. In some cases, the distance between the chain ring and rear derailleur may be about 22 to 24 inches and the distance between opposing pedals may be about 13.5 inches. The length of the member 22 in such a case may, for example, be between about 24, or more inches, and the width of the member 22 may be about 14 inches, or more.

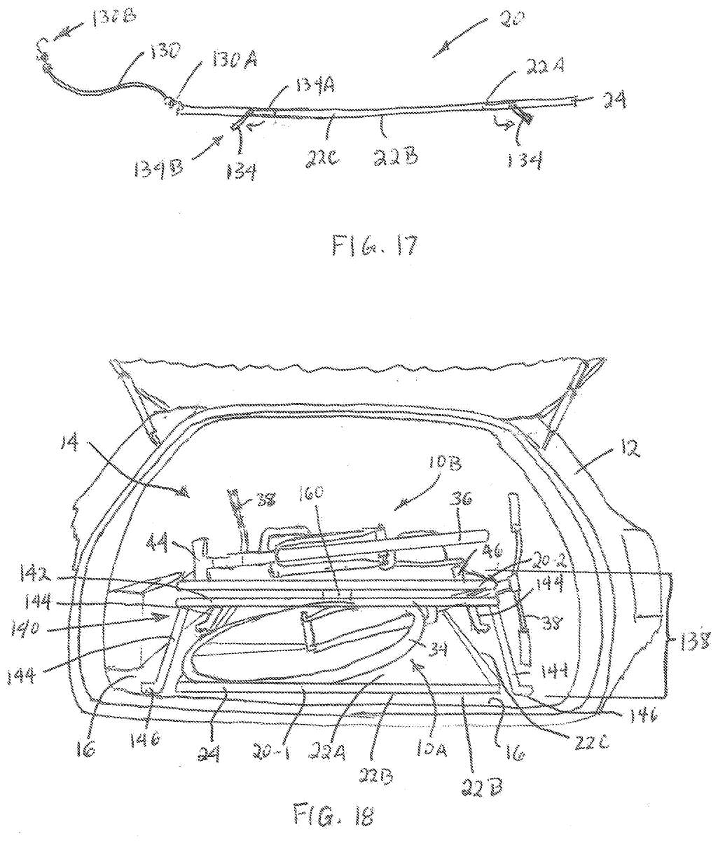

FIGS. 1-4 show embodiments in which the first side 22A of the member 22 underlies and is adjacent to the pedal 46 and at least one axle 66 of a bicycle 10. The second side 22B of the member 22 may be placed on the inside surface of a vehicle. The second side 22B of the member 22 of the transport component 20 comprises at least a portion (its contact surface) that has a lower coefficient of friction that permits the transport component 20 with a bicycle 10 thereon to be slid along the inside surface of a vehicle, which is often covered with carpeting. When it is said that the second side has a lower coefficient of friction, it is meant that the transport component 20 exhibits less resistance to dragging across the inside surface of a vehicle than a bicycle lying on its side without a transport component 20 between the bicycle 10 and the surface. This makes it much easier to load the bicycle into the vehicle. It also reduces the possibility of damaging any carpeting thereon when a person attempts to push a bicycle resting on its side into the back of a vehicle. In some cases, however, it may be desirable for a portion on one end of transport component (e.g., the ground-contacting end) to have a higher coefficient of friction to prevent the transport component 20 from sliding down when the opposite end is placed adjacent to the rear of a vehicle opening such as shown in FIG. 15.

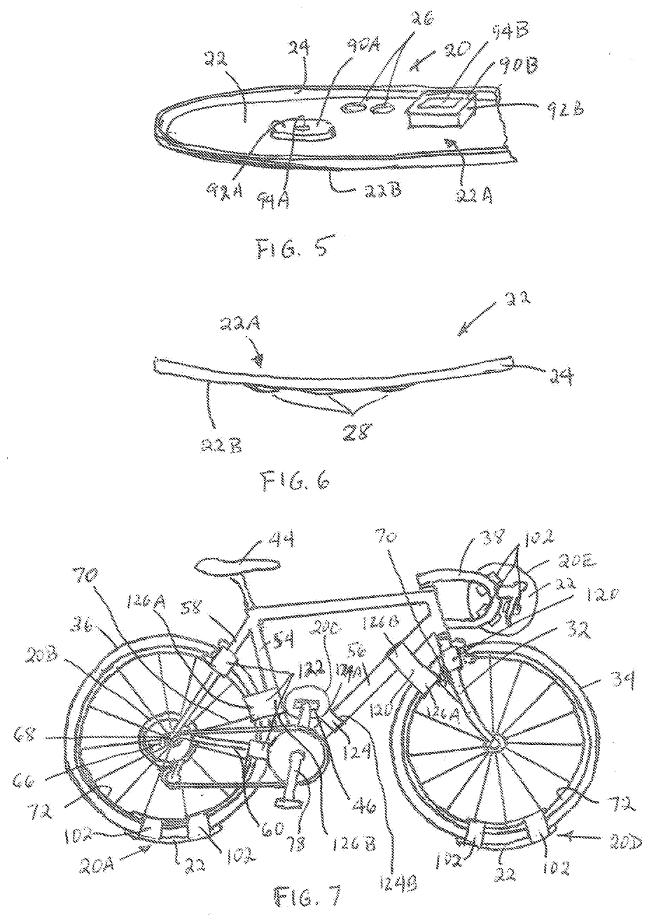

The transport component 20 and member 22 may have any suitable configurations. As shown in FIGS. 1 and 4, in some cases, the member 22 may be generally flat. In some cases, as shown in FIG. 5, the member 22 may have a tray shape. A tray-shaped member 22 can have a lip 24 that forms a short wall extending upwardly from the base of the tray along at least portions of the sides thereof to: help retain bicycle, provide the member 22 with additional rigidity, and/or to facilitate grasping the transport component 20. In some cases, as shown in FIGS. 5 and 6, the member 22 may have first side 22A having at least a portion with a slightly concave curvature, and a second side 22B having at least a portion with a convex curvature, which may be helpful in further reducing friction when the transport component 20 is slid inside the trunk or storage space of a vehicle. The curvature can be in any suitable configuration including, but not limited to in the configuration of a dome, which may be a spherical dome or a non-spherical dome configuration.

In some cases as shown in FIG. 5, the first side 22A of the transport component 22 may be configured (or have an element joined thereto that is configured) to fit part of the bicycle. The part(s) of a bicycle that the first side 22A, or element thereon, can be configured to fit can include any of the surface-contacting parts of the bicycle 10 described above that will come into contact with a surface when the bicycle 10 is laid on its side. For example, FIG. 5 shows a first element 90A that is configured to receive and fit around the end of one of the axles or hubs 66 of the bicycle. The first element 90A can comprise a raised portion 92A having an opening 94A therein that has a circular shape to fit around the extension 68 at the end of one of the axles or hubs 66 of the bicycle. In other cases, the raised portion 92A and the opening 94A can be made larger to fit around more of the hub 66 (or the entire end of the hub 66). FIG. 5 also shows a second element 90B that is configured to receive and fit around a portion of a pedal 46. The second element 90B can comprise a raised portion 92B having an opening 94B therein that has a rectangular, or other shape, that approximates the cross-sectional shape of a bicycle pedal.

The transport component 20 and member 22 may be made out of any suitable material or materials. Suitable materials may include, but are not limited to metals, plastic, fiberglass, and carbon fiber. Suitable metals include steel, aluminum, and titanium. Suitable plastics may include, but are not limited to: polyethylene (PE), polypropylene (PP), polyamide (PA), polyoxymethylene (POM), and polycarbonate (PC). The member 22 may be made by any suitable process, including but not limited to molding such as injection molding, or vacuum forming, in the case of at least some plastics. In some cases, the transport component 20 (or member 22) may comprise a solid or continuous piece of material. In other cases, the member 22 may comprise two or more components or pieces of material that are joined together.

In other cases as shown in FIG. 5, the member 22 may have one or more holes 26 therein for the purpose of reducing the weight of the transport component, and/or reducing the amount of material in the member 22. There can be any suitable number of holes 26, and the holes can be of any suitable size and shape. The holes 26 may be in any suitable portions of the member 22 up to half of the total surface area of the member, or more. However, it may be desirable for holes to be omitted from those portions that will be in contact with a horizontal surface when the member 22 is placed on such a surface, so that the holes 26 do not interfere with sliding of the member 22 across the surface.

The first side 22A of the member 22 comprising the transport component 20 can be rigid. Alternatively, at least a portion of the first side 22A of the member 22 can be molded or padded, or have some other feature joined thereto to protect the bicycle from contact with rigid portions of the member 22. For example, the elements 90A and 90B described in conjunction with FIG. 5 can be made of a softer, less rigid material than the first side 22A of the member 22. Suitable materials include, but are not limited to softer plastics and rubber.

The second side 22B of the member 22 comprising the transport component 20 (or at least a portion of the second side) can comprise a material to assist in sliding the transport component 20 along the surface of a trunk or storage compartment of a vehicle. Suitable materials include, but are not limited to: polytetrafluorethylene (PTFE, e.g. sold under the brand name TEFLON®); elastomers and thermoplastic elastomers (TPE) with foil made out of polytetrafluorethylene (PTFE); ultrahigh molecular weight PE; cross-linked ultrahigh molecular weight PE); and other materials such as those that are used on carpet sliders for moving furniture. (It is expressly not admitted that carpet sliders for moving furniture teach or disclose the claimed invention.)

In addition, in some cases, as shown in FIG. 6, raised sliding elements and/or runners 28 can be joined to the second side 22B of the member 22. Such sliding elements or runners 28 can be used to minimize the portions of the second side 22B of the member 22 that will contact the inside surface of a vehicle in order to facilitate sliding of the member 22 across the inside surface of the vehicle. Such sliding elements or runners 28 can also have contact surfaces that are made of a lower coefficient of friction material than other portions of the second side 22B of the member 22. This can facilitate manufacturing of the member 22 and/or reduce the amount of low coefficient of friction material that needs to be provided on the second side 22B of the member 22.

In some cases, as shown in FIG. 2, the member 22 may have fasteners joined thereto in order to hold the bicycle in position on the member 22 and/or to temporarily join the bicycle transport component to a part of a bicycle. The fasteners may be referred to generally by reference number 100 and individual fasteners as 100A, 100B, and 100C, etc. The fasteners 100 may have one or more proximal portions that are joined to the member 22 (such as to the first side 22A or the side edges of the member) and one or more distal portions that are used for temporarily joining the transport component 20 to at least a portion of the bicycle. The fasteners 100 can be of any suitable type, and can hold any part of the bicycle 10 to the member 22. The fasteners 100 can, for example, be used to hold one or more of: the frame 30, the wheels 34 and 36, the handle bars 38, the pedals 46, and the hubs 66 to the member 22.

Suitable fasteners include, but are not limited to: straps, bungee cords, and clips. Straps can be provided with a hook and loop fastening material (such as VELCRO®) thereon to allow repeated fastening and unfastening of the straps. The member 22 and any fasteners thereon may also have any of the features described below (in conjunction with FIG. 7) with respect to the plurality of transport components that form a set of transport components.

FIG. 2 shows an example of a member 22 having: a front wheel fastener 100A for fastening the front wheel 34 to the member 22 and reducing rotation of the front wheel 34; a rear wheel fastener 100B for fastening the rear wheel 36 to the member 22 and reducing rotation of the rear wheel 36; and a handlebar fastener 100C for the handlebars 38. Such fasteners 100 can also be provided on any of the other embodiments shown and/or described herein.

The transport component 20 can, as shown in FIG. 2, further comprise one or more handles 98 joined to the member 22. The handle(s) 98 may, depending on its intended use, be partially or entirely any of the following: flexible, substantially rigid, or rigid. For example, in some cases, the handle may be configured to push the bicycle 10 back into the vehicle. In such cases, the handle 98 may be substantially rigid, or rigid. If desired, the handle 98 may be a telescoping handle. In other cases, the handle may be used to lift the transport component 20. In such cases, the handle 98 may be partially or entirely flexible, substantially rigid, or rigid. An example of a flexible handle 98 in the form of a rope is shown in FIGS. 14-16. Such a handle 98 can be configured to be raised above the surface of the transport component 20 (e.g., 90 degrees) upward to help lifting, so the user does not have to bend over as much to lift the transport component 20. A rope handle can work nicely since it is lightweight and can lie down to load the bicycle. The rope handle may comprise one or two (or more) ropes with or without a knot on the ends which the user may grab the ropes with their hand(s). In other cases, a single rope configured into a U-shape can also be used.

In addition, as described above, there may be more than one transport component 20 for a single bicycle 10. FIG. 7 shows an embodiment in which there is a plurality of transport components (comprising a “set” of bicycle transport components) for a bicycle 10. Any suitable number of transport components can be provided in a given set for a bicycle. In this particular embodiment, five transport components are provided. These comprise from left to right: a wheel transport component 20A for the rear wheel 36; a rear hub transport component 20B underlying the hub 66 of the rear wheel; a pedal transport component 20C for the pedal 46 that is closest to the surface; a wheel transport component 20D for the front wheel 34; and, a handlebar transport component 20E for the handle bar 38 that is closest to the surface. There can be fewer than five transport components (e.g., two, three, or four) in a set, and this will still provide some of the benefits of reduction in resistance to sliding of the bicycle along the inside surface of a vehicle. Of course, more than five transport components can be provided in a set. The transport components in such sets of transport components can have any of the features and properties described above in conjunction with FIGS. 1-4 of the transport components that cover more than one surface-contacting part of a bicycle.

The wheel transport components 20A and 20D are configured to be temporarily joined to a wheel of bicycle. The wheel transport components 20A and 20D can have any suitable configuration. FIGS. 7 and 8 show two different versions of one of the wheel transport components 20A. The wheel transport components 20A and 20D can optionally comprise raised sliding elements 28 on their side and/or bottom surfaces. The wheel transport components 20D and 20A for the front and rear wheels 34 and 36 can be of the same configuration, or of different configurations. The wheel transport components 20A and 20D shown in FIG. 7 may be generally planar. In other cases, the wheel transport components 20A and 20D may have a concave first side 22A and a convex second side 22B that is configured to fit the curvature of the side of the bicycle wheel. FIG. 8 shows that in other cases, the wheel transport component 20A may have a U-shaped cross-section to fit adjacent to both sides of a wheel. As shown in FIGS. 7 and 8, in both versions, at least a portion of the member 22 comprising wheel transport component 20A may have an arcuate shape along its length that approximates the arcuate shape of a portion of a bicycle wheel. Of course, any other suitable shapes are possible. In some cases, such U-shaped wheel transport components 20A may be flexurally resilient so that their sides may be spread apart to place the wheel transport component 20A around a portion of the side of a wheel and then retract to return toward their original configuration in order to clip onto the wheels (without a separate fastener for the purpose).

The wheel transport components 20A and 20D may have any dimensions that are suitable for eliminating direct contact of the tires with the inside surface of the vehicle when the bicycle is slid into the vehicle. In some cases, the wheel transport components 20A and 20D may have a length that is greater than or equal to about 6, 7, 8, or 9 inches to about 12 inches or more and a width that ranges between about 1 or 1.5 inches and about 2, 3, or 4 inches or more.

The wheel transport component 20A may further comprise at least one fastener 102 joined to its member 22 which is configured to fasten around the rim 72 of the wheel in order to hold the wheel transport component 20A in place. Any of the types of fasteners described herein may be used for this purpose. The fasteners 102 on the wheel transport components 20D and 20A may be joined to any suitable portion of the respective front and rear wheels 34 and 36. For example, the fasteners 102 may wrap around a portion of the wheels between the spokes 70. In some cases, the fastener 102 may comprise portions that are located adjacent to each side of a spoke 70. Additionally, or alternatively, the fastener 102 may attach to one or more of the spokes 70.

The rear hub transport component 20B underlying the hub of the rear wheel 36 may be configured to cover any portion of the hub 66 that would otherwise contact the inside surface of a vehicle. The rear hub transport component 20B may have any suitable configuration including, but not limited to a circular plan view shape as shown in FIGS. 7 and 9. It may be of a large enough diameter to cover all portions of the end of the hub 66 that would otherwise contact the inside surface of a vehicle. The rear hub transport component 20B may, for example, have a diameter of 4, 5, 6, 7 inches up to about 9 inches, or more. FIG. 9 shows that in some cases, the rear hub transport component 20B comprises a substantially rigid member 22 having a portion of its first side 22A (or an element joined to its first side) that may be configured to be temporarily joined to a threaded extension 68 at the end of an axle of the wheel of a bicycle. The configuration of the portion of transport component (or such an element) may be cylindrical with an opening therein that is designed to either fit closely onto (or screw onto) the threaded extension 68 at the end of the axle that comprises part of the hub 66. The rear hub transport component 20B may have an axis, A, that is configured to align with the axle of a bicycle wheel. As shown in FIG. 9, the substantially rigid member 22 may have side edges 106 that are rounded in a direction parallel to the axis to aid in sliding of the rear hub transport component 20B across a surface.

The rear hub transport component 20B may further comprise at least one fastener 102 joined to its member 22 which is configured to fasten the member 22 to any suitable part of the bicycle 10 in order to hold the rear hub transport component 20B in place. (Some of the fasteners have been omitted from FIG. 7 for simplicity and clarity of illustration.) For example, as shown in FIG. 9, the rear hub transport component 20B may have one or more straps 102 that wrap around part of the bicycle other than the rear hub and either attach to that part of the bicycle and reattach to a portion of the member 22, or reattach to another portion of the strap. Additionally, the rear hub transport component 208 may have at least one alternative type of fastener 108 in the nature of a clip joined thereto. This clip fastener 108 has a proximal end 108A which may be joined to the first side 22A of the member 22 and a distal end 108B spaced away from the first side 22A of the member 22. The clip fastener 108 may further comprise a pair of flexible elements 110 with a space therebetween that are configured for clipping onto one or more of the seat stays 58 and/or chain stays 60. Any other suitable type of clip mechanisms can be used instead of flexible element-type clips. There can be two or more clip fasteners 108 on the rear hub transport component 208 for fastening the rear hub transport component 201 to one or more of the seat stays 58 and/or chain stays 60.

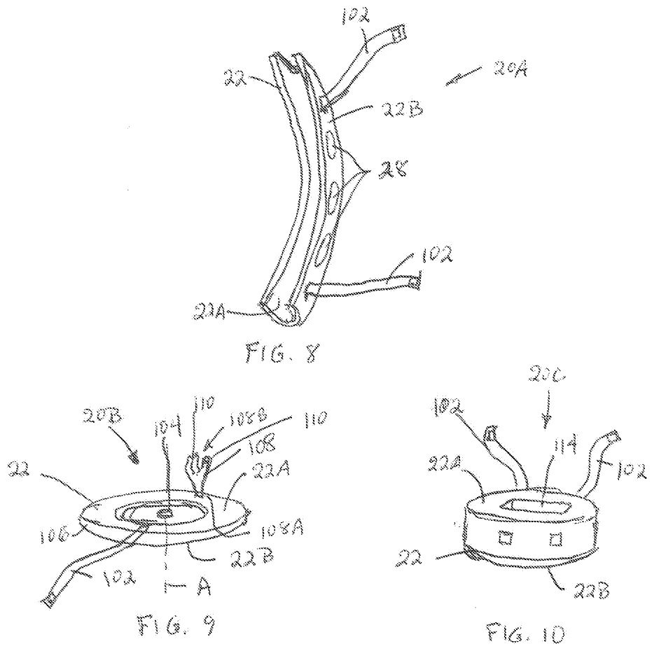

The pedal transport component 20C is configured to be temporarily joined to a pedal 46 of a bicycle. As shown in FIG. 10, the first side 22A (or an element joined to the first side) of the member 22 comprising the pedal transport component 20C may have a recess 114 therein for receiving at least a portion of the pedal 46 of a bicycle. The element joined to the first side 22A may comprise a softer and/or less rigid material than the member 22 and may extend outward from the first side of the member 22. The member 22 of the pedal transport component 20C will typically have dimensions that are at least greater than the dimensions of the side of the pedal that would otherwise contact inside surface of the vehicle when the bicycle is slid into the vehicle. In addition, it may be desirable for the member 22 of the pedal transport component 20C to be slightly larger than such minimum dimensions to facilitate sliding of the same. Further, it may also be desirable for the member 22 thereof to have a circular configuration to facilitate sliding. In some cases, the side of the pedal may have dimensions that are about 1 inch by about 3 inches, more or less in either dimension. In some of such cases, the member 22 of the pedal transport component 20C may, for example, have a diameter that is greater than about 3.5, 4, 5, or 6 inches and less than or equal to about 9 inches. The pedal transport component 20C may further comprise at least one fastener 102 joined to its member 22 which is configured to fasten around a portion of the pedal 46 and/or crank arm 78 of a bicycle. The pedal transport component 20C can alternatively, or additionally, be provided with one or more clip fasteners similar to those described in conjunction with FIG. 9 that clips onto the pedal 46 and/or crank arm 78 of a bicycle.

The handlebar transport component 20E (and the member 22 comprising the same) will typically have dimensions that are at least greater than the dimensions of the side of the handlebar that would otherwise contact inside surface of the vehicle when the bicycle is slid into the vehicle. In addition, it may be desirable for the handlebar transport component 20E to be slightly larger than such minimum dimensions to facilitate sliding of the same. Further, it may also be desirable for the member thereof to have a circular plan view configuration to facilitate sliding. The handlebars may be of different styles, each of which may have surface-contacting parts with different dimensions. In some cases, the side of the handlebar may have dimensions that are about 5 to 10 inches in one dimension by about 2 to 6 inches in a perpendicular dimension, or more or less in either dimension. In some of such cases, the member of the handlebar transport component 20E could have a generally rectangular configuration that may, for example, be about 3, 4, 5, 6 inches by about 6, 7, 8, 9, or more inches. Alternatively, the member of the handlebar transport component 20E may, for example, have a circular configuration with a diameter that is greater than about 5, 6, 7, or 8 inches and less than or equal to about 9, 10, 11, or 12 inches.

FIG. 7 also shows that immobilizing components 120, 122, and 124 may additionally be provided to keep parts of the bicycle 10 from moving when the bicycle is slid into the storage space of a vehicle. Any suitable immobilizing components can be used, having any suitable configurations. In FIG. 7, the immobilizing components comprise: a front wheel immobilizing component 120 for the front wheel 34 that at least partially reduces (or prevents) rotation of the front wheel 34; a rear wheel immobilizing component 122 for the rear wheel 36 that at least partially reduces (or prevents) rotation of the rear wheel 36; and, a pedal immobilizing component 124 that at least partially reduces (or prevents) rotation of the pedals 46.

The front and rear wheel immobilizing components 120 and 122 can comprise any suitable type of article of manufacture that at least partially reduces the rotation of the wheels. Suitable types of articles for the front and rear wheel immobilizing components 120 and 122 include, but are not limited to: straps (such as with hook and loop fastening material (e.g., VELCRO®) thereon), clips (such as those described above), zip ties, twist ties, ribbons, rope, and strings. In the embodiment shown, the front and rear wheel immobilizing components 120 and 122 may comprise any of the foregoing types of articles.

The wheel immobilizing components 120 and 122 may comprise two portions. These portions may be different parts of a single element. Alternatively, they may comprise two different elements that are joined together. The two portions of the wheel immobilizing components 120 and 122 comprise a wheel holding portion 126A and a fixed portion connector 126B.

The wheel holding portions 126A of the front and rear wheel immobilizing components 120 and 122 may be temporarily and removably joined to a portion of the front wheel 34 and rear wheel 36, respectively. The wheel holding portions 126A of the wheel immobilizing components 120 and 122 may be joined to any suitable portion of the respective front and rear wheels 34 and 36. For example, the wheel holding portion 126A of the wheel immobilizing components 120 and 122 may wrap around a portion of the wheels between the spokes 70. In some cases, the wheel holding portion 126A may comprise portions that are located adjacent to each side of a spoke 70. Additionally, or alternatively, the wheel holding portion 126A may attach to one or more of the spokes 70.

The fixed portion connector 126B of the front wheel immobilizing component 120 may be temporarily and removably joined to any fixed portion(s) of the bicycle, such as to a portion of the frame 30 or frameset. The term “fixed portion(s)” of the bicycle refers to portions of the bicycle that do not rotate. The fixed portion connector 126B of the wheel immobilizing components 120 and 122 may, therefore, alternatively be referred to as a “frameset-engaging portion” or “frame-engaging portion”. The fixed portion connector 126B of the front wheel immobilizing component 120 may, for example, be configured to be joined to the fork 32, and/or the down tube 56. The fixed portion connector 126B of the rear wheel immobilizing component 122 may, for example, be configured to be joined to one or more of the following: the seat tube 54; one or both of the seat stays 58; and one or both of the chain stays 60.

The pedal immobilizing component 124 can comprise any suitable type of article of manufacture that at least partially reduces the rotation of the pedals 46. Any of the types of articles of manufacture used for the wheel immobilizing components (e.g., straps, clips, zip ties, twist ties, ribbons, rope, and strings) can be used as part of the pedal immobilizing component 124. In addition, in some cases, it may be desirable for at least a portion of the pedal immobilizing component 124 to be substantially rigid to further assist in reducing rotation of the pedals 46 in either direction. The pedal immobilizing component 124 may also comprise two portions. These comprise a first portion 124A that may be temporarily and removably joined to at least one of: the pedal 46, the crank arm 28, or the pedal transport component 20C, and a second fixed portion 124B that may be temporarily and removably joined to part of the frame of the bicycle 10. In some cases, the first portion 124A of the pedal immobilizing component 124 may be permanently joined to the pedal transport component 20C. The fixed portion 1248 can be temporarily and removably joined to any suitable part of the frame 30 including, but not limited to the seat tube 54 and/or the down tube 56.

The various embodiments of the transport components 20 can be used in any suitable manner.

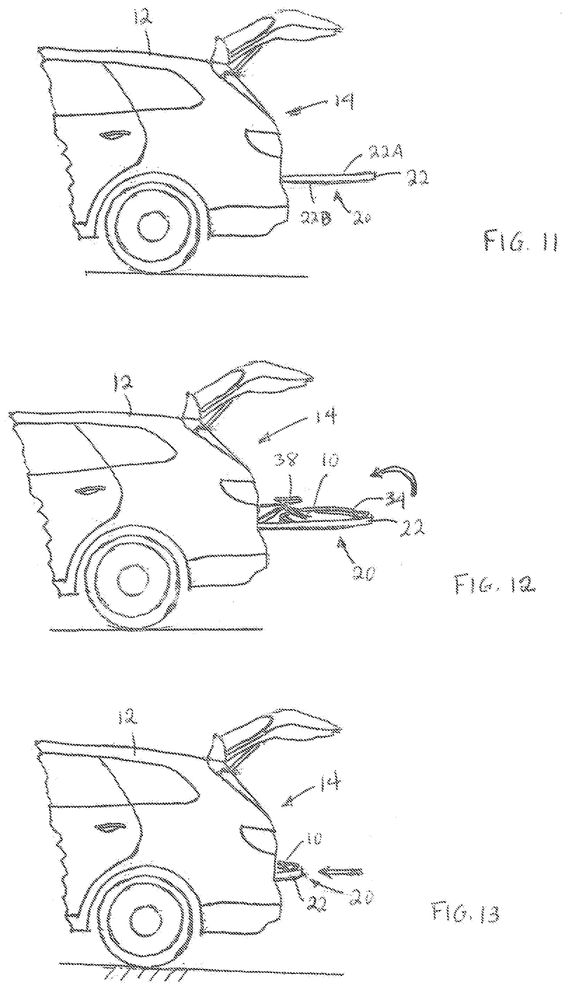

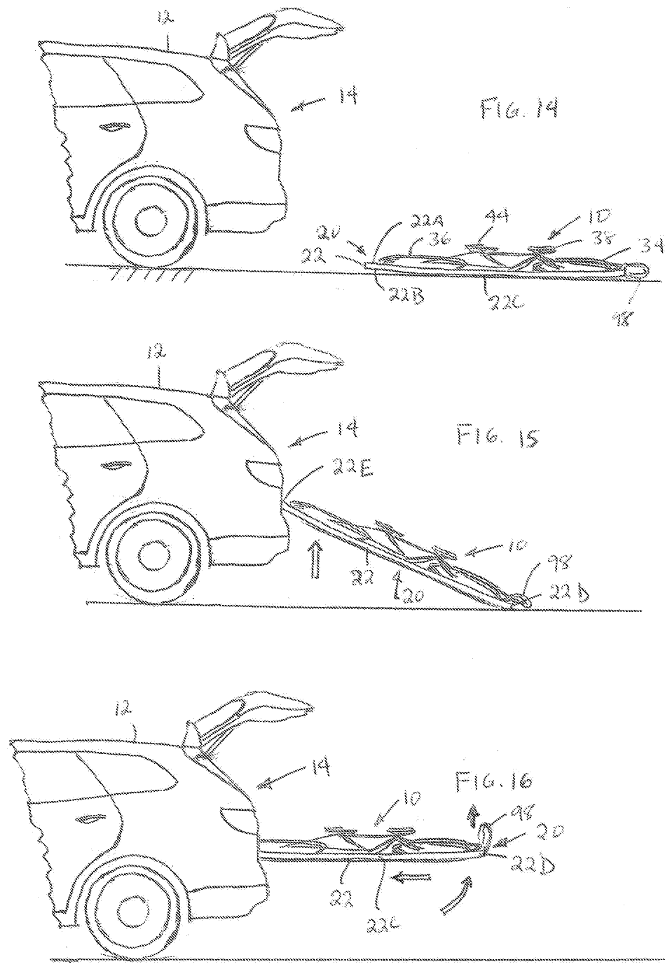

In some cases, as described above, the transport component 20 may serve as a bicycle carrier. Such a transport component 20 can be used as a bicycle carrier in any suitable manner. FIGS. 11-13 show that in some cases, the transport component 20 may be placed at least partially in position in the back of a vehicle 12 (FIG. 11), and the bicycle 10 may then be laid on its side on the first surface 22A of the member 22 comprising the transport component 20 (as shown in FIG. 12). Depending on the configuration of the transport component 20, the bicycle may be oriented so that either end of the bicycle may be placed into the vehicle first. In the embodiment shown, the end with the rear wheel is placed into the vehicle first. The transport component 20 with the bicycle 10 thereon may then be pushed on in order to slide the transport component 20 with the bicycle 10 thereon all the way into the desired position in the trunk or storage space of the vehicle (as shown in FIG. 13). This method of loading the vehicle 12 may be used in those cases in which the transport component 20 either does not have fasteners for holding a bicycle in place; or, in which it has fasteners, but the user wants to forego using the fasteners.

In other cases, as shown in FIG. 14, the transport component 20 may be placed on the ground behind the vehicle 12 (or on any other suitable surface), and the bicycle 10 can be placed on the first surface 22A of the transport component 20, and fastened thereto. FIG. 15 shows that the user can then lift up the first or second end 22D or 22E (end 22L as shown) of the transport component 20 with the bicycle 10 thereon, and place that end on the rear of the vehicle such as on the rear bumper or at the rear edge of the opening of the trunk or storage space of the vehicle. The user can then move to the other end of the transport component, and as shown in FIG. 16, lift that end (e.g., 22D) and push the transport component 20 with the bicycle thereon into the desired position in the trunk or storage space of the vehicle.

Alternatively, if there are two people available to load the bicycle 10 into the vehicle 12, each person can grasp one of the longitudinal sides 22C of the member 22 in order to lift and slide the transport component 20 into the back of the vehicle. In such a case, the step shown in FIG. 15 is not necessary, and the loading steps can proceed directly from the step shown in FIG. 14 to the step shown in FIG. 16.

FIGS. 11-16 show methods of loading a transport component 20 that is configured to serve as a carrier for a bicycle 10. In embodiments where the transport component(s) 20 are smaller and not configured to serve as a carrier to assist in lifting and carrying a bicycle, the user may place the transport component(s) 20 in the trunk or storage space of a vehicle and lift the bicycle 10 and place the bicycle on the transport components 20, and slide the transport components with the bicycle 10 thereon in place. Alternatively, the user can fasten the transport component(s) 20 to the bicycle 10 when the bicycle is either in an upright condition, or when the bicycle is laid on one side (typically, opposite the side on which the bicycle will be slid into the vehicle). The user can then and lift the bicycle 10 with the transport components 20 joined thereto, and place the bicycle 10 with the transport components 20 joined thereto in the trunk or storage space of a vehicle with the member 22 positioned between the bicycle and the surface of the storage space, and slide the bicycle and underlying transport components 20 in place. Any immobilizing components can be placed on the bicycle 10 before it is placed into the vehicle 12. Although in these cases, the transport component(s) 20 may not provide help with lifting the bicycle, they will help with sliding the bicycle into the vehicle.

When the bicycle is loaded into the vehicle, it may further be desirable to fasten the transport component(s) 20 to some portion of the inside of the vehicle 12 in order to reduce the potential for the transport component 20 to slide in an undesired manner within the storage space while the bicycle 10 is being transported. This can be done in any suitable manner with any suitable type of fastener such as straps or bungee cords. For example, as shown in FIG. 17, it may be desirable to use bungee cords 130 for this purpose. One end (proximal end) 130A of a bungee cord 130 can be fastened to the member 22 of the transport component 20, or to the bicycle 10, and the other end (distal end) 130B of the bungee cord 130 can be fastened to a component on the inside of the vehicle. Any suitable number of such fasteners (one, two, three, four, etc.) can be joined to any suitable portion of the bicycle 10 or the member 22 and attached to any suitable components on the inside of the vehicle.

Additionally or alternatively, as shown in FIG. 17, the transport component 20 may be provided with deployable elements that can be engaged to prevent the transport component 20 from undesired sliding within the vehicle. For example, the transport component 20 can have deployable legs 134 that can be extended to contact the inside surface of the vehicle 12 to prevent the transport component 20 from sliding within the storage space while the bicycle 10 is being transported. FIG. 17 shows one example in which the deployable legs 134 can be rotated from a first position 134A aligned generally parallel to the longitudinal edges 22C of the member 22 of the transport component 22 to a second deployed position 134B in which the legs extend downward at an angle below the surface formed by the second side 22B of the member 22.

When it is desired to unload the bicycle 10, the steps shown in FIG. 11-13 or 14-16 can be performed in reverse order. For instance, the transport component 20 with the bicycle 10 thereon may be pulled forward until the bicycle can be unfastened (if fastened and) removed from the transport component 20. Alternatively, the user may pull the transport component 20 with the bicycle 10 thereon forward and tip the transport component 20 downward until one end of the transport component 20 rests on the ground and the other end rests on the vehicle. The user can then grasp the other end of the transport component 20 and gently lower it onto the ground so that the second side 22B of the member 22 comprising the transport component 20 is flat on the ground, and then unfasten and remove the bicycle 10 from the transport component 20. In either case, once the bicycle 10 is removed from the transport component 20, the transport component(s) 20 may be stored in the trunk or storage space of the vehicle while the bicycle 10 is being used.

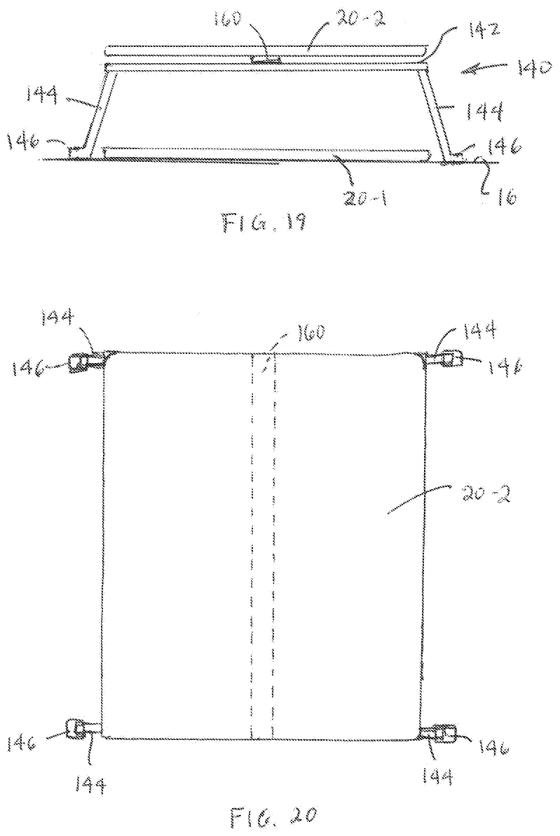

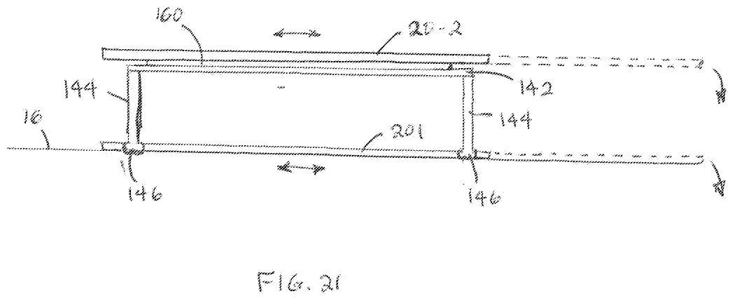

FIG. 18 shows that if it is desired to transport two bicycles in a vehicle, the bicycle carrier system 138 may further comprise, among other things, an optional supporting component 140 for supporting a second bicycle 10B above the first bicycle 10A. FIG. 18 shows one non-limiting embodiment of such a bicycle carrier system 138. FIGS. 19-21 are several different views of the bicycle carrier system 138 shown in FIG. 18. It should be understood, however, that the bicycle carrier system is not required to have all the components and features shown in FIGS. 18-21. In addition, when it is said that the supporting component may be optional, in such cases where a supporting component is not used, a second bicycle can be placed onto a second bicycle carrier and slid into a vehicle on top of the first bicycle.

The supporting component 140 may comprise a structure having a surface on which a second bicycle 10B may be placed directly or indirectly. The supporting component 140 may be in the nature of a platform, shelf, or a stand that is disposed above the first bicycle 10A. The supporting component 140 may, in some cases, be in the form of a stand that is either configured to fit in a variety of different vehicles, or that can be adapted to fit in a variety of different vehicles. The supporting component 140 may comprise, a platform 142 and a plurality of legs 144 that are configured to extend downward from the platform 142 to the inside surface 16 of the trunk or storage portion 14 of the vehicle and space the platform 142 above the first bicycle 10A.

The supporting component 140 may have any suitable characteristics. The supporting component 140 may be lightweight so that it may be easily positioned into the trunk or storage space 14 of the vehicle 12, and can be easily removed therefrom. The supporting component 140 should be sufficiently strong so that it is capable of supporting the weight of the second bicycle 10B and the second transport component 20-2 described below FIGS. 18-21 show that the supporting component 140 may further comprise an optional drawer-type slide 160 on upper surface of the platform 42 for engaging the underside of the second transport component 20-2. The drawer-type slide 160 may also be configured to allow tipping of the second transport component 20-2 for loading and unloading.

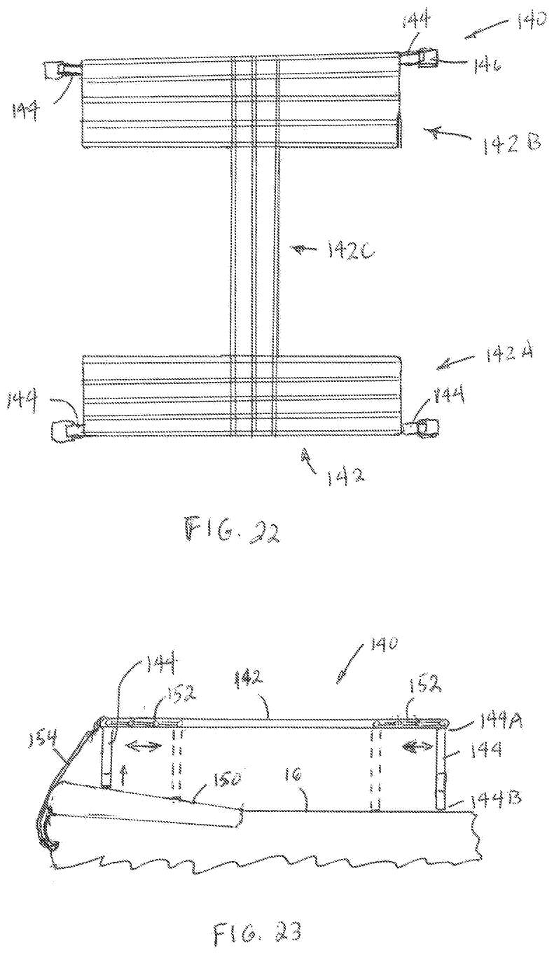

The platform 142 may be of any suitable size and shape. Suitable sizes include, but are not limited to smaller in some or all of its dimensions than the plan view dimensions of a bicycle (such as a first bicycle 10A) lying on its side to larger in dimensions than a bicycle lying on its side. Suitable shapes include, but are not limited to square, rectangular, f-shaped, rounded corner versions of any of the foregoing, and any other suitable shapes. As shown in FIG. 22, an I-shaped platform 142 may comprise a front portion 142A, a rear portion 142C, and a central portion 142B that connects the front and rear portions 142A and 142C. This can provide the supporting component 140 with stability and support both ends of a bicycle, while reducing the weight of the platform 142 in the areas that are not essential to support the bicycle.

There can be any suitable number of legs 144. Suitable numbers of legs include two, three, four, five, six, seven, eight, or more legs. The legs 144 may extend downward at a right angle from the platform 142. In other cases, as shown in FIGS. 18 and 19, one or more of the legs 144 may angle outward away from the platform 142 for stability. In some cases, the legs 144 may be configured to contact and/or engage the side wall of the vehicle interior 14.

The supporting component 140 can be made out of any suitable material or materials. Suitable materials include, but are not limited to metals and plastics, and combinations thereof. For example, some portions of the supporting component 140 may be comprised of metal, and some portions may be comprised of plastic. Suitable metals and plastics may include those specified above for the member 22 of the transport components 20. FIG. 22 shows one example of a suitable supporting component 140 comprises a platform 142 that is constructed similarly to a wire rack shelving material with metal legs extending therefrom. The legs 144 may be solid or hollow (e.g., tubular).

The legs 144 have proximal ends 144A adjacent to the platform 142 and distal ends 144B that are intended to be positioned directly or indirectly on the surface of the trunk or storage space of the vehicle. The distal ends 144B of the legs 144 may be provided with feet 14o thereon for any suitable purpose. For example, the distal ends 1448 of the legs 144 may be provided with non-slip (or reduced tendency to slip) feet 146 thereon. Such feet 146 may be made of any suitable material including, but not limited to plastic or rubber.

FIG. 23 shows that the legs 144 may be adjustable in length (e.g., telescoping) to adjust the height of the platform 142, or portions thereof, above lower bicycle. The adjustability of the legs 144 may be such that different legs may be extended different amounts. For example, in an SUV, when the seats 150 are folded down, the surface formed by folding the seats down may slope upward toward the front of the vehicle. As a result, it may be desirable for the legs 144 that are closest to the front of the vehicle 12 to be extended a lesser amount than the legs closest to the rear of the vehicle.

FIG. 23 also show that the proximal ends 144A of the legs 144 may be repositionable along the length of the platform 142 (e.g., slidable legs) to locate the legs 144 precisely relative to the lower bicycle 10A and first transport component 20-1. As shown in FIG. 23, one way of making the legs 144 repositionable is by providing a track 152 with several locations (optionally in the form of openings) for fastening the proximal end 144A of the legs 144 along the length of the platform. (The legs 144 can similarly be repositionable along the width of the platform.) Providing the legs 144 with repositionability may allow the distal ends 144B of the legs 144 to be placed in specific locations such as either inward or outward of the some or all portions of the lower bicycle 10A and first transport component 20-1. The term “inward”, as used herein, refers to in a direction toward an imaginary line, L, shown in FIG. 4 running between the hubs 66 of the bicycle when the bicycle is laid on its side on a surface and is viewed from above. The term “outward” refers to a direction away from such an imaginary line. FIG. 4 shows some non-limiting examples of locations marked by “X's” that the distal ends 1448 of the legs may be positioned.

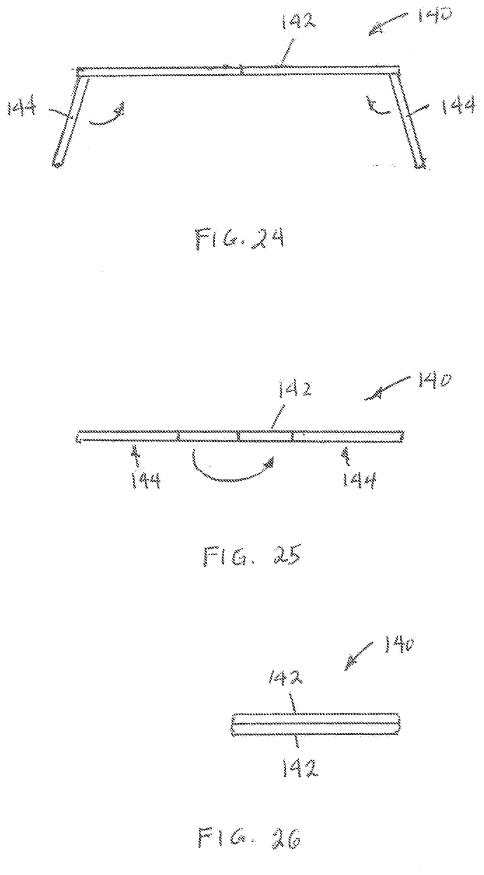

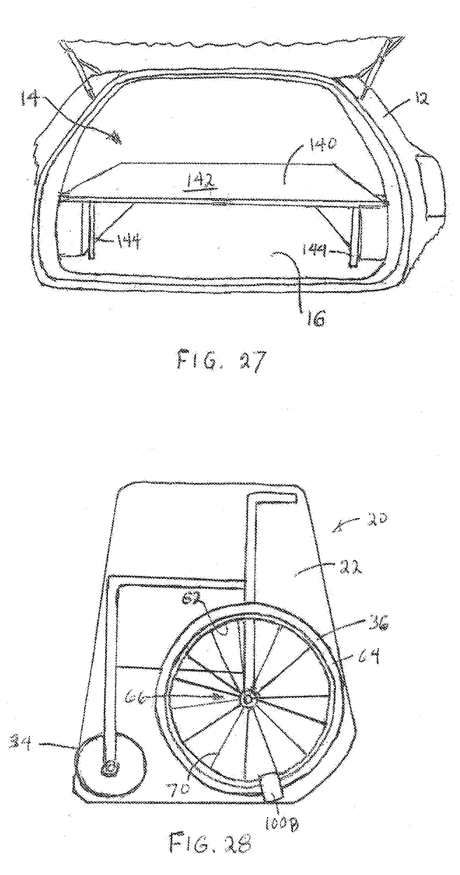

As shown in FIG. 24, the legs 144 may be foldable for storage of the supporting component 140. FIGS. 25 and 26 show that the supporting component 140 may be foldable so that it can be easily removable from the trunk or storage space of the vehicle, and/or stored outside of the vehicle, such as in a garage.

The supporting component 140 may further be provided with one or more fasteners 154 to prevent the supporting component 140 from moving while the vehicle 12 is moving and/or while moving a bicycle 10 into position on top of the same, or removing a bicycle 10 from on top of the same. The fasteners 154 can be any suitable type of fasteners including, but not limited to straps and bungee cords. There can be any suitable number of fasteners that are connected to any suitable portions of the supporting component and the vehicle 12. FIG. 23 shows one non-limiting example of a fastener in the form of a bungee cord 154 that is attachable to the lip underside of the second row of seats.

FIG. 27 shows that in other cases, the supporting component 140 may be in the form of a shelf, or horizontally-oriented trunk divider that is configured to fit a particular model of vehicle. The shelf or divider can also be provided with legs 144 similar to the supporting component described above, if it is desired to provide the shelf or divider with additional support. Such a shelf or divider can be made in any suitable manner. For example, the shelf or divider can be laser a measured and/or cut piece for each different model of vehicle. The shelf or divider can be removable from and vehicle and/or foldable. If desired, the shelf or divider can have one or more removable portions that can be removed to make space for the handle bars, or other parts, of the lower bicycle.

FIGS. 18-21 show that the bicycle carrier 20 may further comprise a second transport component 20-2 for a second bicycle 10B. In such a case the transport component for the first bicycle 10A may be referred to as the first transport component 20-1. The second transport component 20-2 may have at least some of the same features and properties described above for the first transport component 20-1. In some cases, the second transport component may have all, or substantially all of the same features and properties and properties of the first transport component. In such a case these components can be substantially identical and/or interchangeable. By “substantially identical”, it is meant that the second transport component is the same in all respects as the first transport component, within manufacturing tolerances.

In other cases, the second transport component 20-2 may differ from the first transport component 20-1 in any or all of its features and properties. Whether this is the case may depend on the properties of the supporting component 140. For instance, the first transport component 20-1 for the first bicycle 10A may either comprise a single bicycle carrier or a set of bicycle transport components, but if the supporting component 140 comprises a wire mesh platform 142, it may be desirable for the second transport component 20-2 to be in the form of a bicycle carrier to facilitate sliding of the second transport component on the platform 142.

To use the bicycle carrier system 138 to carry two bicycles in the interior of a vehicle, the first bicycle 10A may be placed on the first transport component 20-1 and slid into the back of the trunk or storage space of the vehicle 12 as described above. (Or the transport components 20 may be joined to the bicycle 10A and the bicycle with the transport components 20 positioned between the bicycle and the inside surface of the vehicle, is slid into the vehicle.) This can occur either before, or after the supporting component 140 is in place in the vehicle so long as the location of the legs 144 of the supporting component 140 would not interfere with the sliding of the first bicycle 10A on the first transport component 20-1 underneath the same. Typically, however, the first bicycle 10A and first transport component 20-1 are slid into the vehicle 12, and then the supporting component 140 is placed in the trunk or storage space of the vehicle so that the platform 142 is located above the first bicycle 10A and the first transport component 20-1. The second bicycle 10B is then placed on the second transport component 20-2 similarly to the manner described above in which the first bicycle 10A was placed on the first transport component 20-1. The second transport component 20-2 with the second bicycle 10B thereon can be lifted up to the level of the top of the supporting component 140, and slid on top of the same into the back of the trunk or storage space of the vehicle. Since there will likely be two people loading bicycles into the vehicle, each person can grasp one of the longitudinal sides of the second transport component 20-2 in order to lift and slide the transport components into the back of the vehicle. The second transport component 20-2 can then be fastened down in any of the manners described above with respect to the first transport component 20-1. The bicycles 10A and 10B can be removed from the vehicle (using the opposite steps that were performed in loading the vehicle) similarly to that described above in loading and unloading a single bicycle.

Numerous other embodiments of the bicycle transport components, the bicycle carriers, and the bicycle carrier systems, and features thereof, are possible. For example, it may be desirable to provide some of the larger bicycle carriers described herein from two or more pieces that are joined together with hinges to make such larger bicycle carriers foldable for storage. In addition, in other embodiments, any of the bicycle transport components described herein, or any of the features of any of the bicycle transport components described herein can be combined in any suitable manner to produce still other embodiments. In still other embodiments, the transport components, carriers, and carrier systems can be used to assist in sliding articles other than bicycles into vehicles. As shown in FIG. 28, such other articles include, but are not limited to wheel chairs and patient transport chairs. In such cases, the term “bicycle” used herein can be replaced with the name of such other article (e.g., wheel chair).

The bicycle transport components, bicycle carriers, and bicycle carrier systems, described herein may provide one or more advantages. It should be understood, however, that such advantages are not required or to be considered to be part of the invention(s) described herein, unless they are expressly set out in the appended claims. The bicycle transport components, bicycle carriers, and bicycle carrier systems are capable of being securely positioned inside a vehicle with the bicycle(s). The bicycle transport components, bicycle carriers, and bicycle carrier systems do not require that the vehicle have a trailer hitch. There is no need to lift the bicycle(s) up onto the roof of a vehicle. The majority of the bicycle transport components, bicycle carriers, and bicycle carrier systems described herein do not require anything be bolted into the inside of the vehicle. There is no need to take the bicycle apart to put the bicycle inside the vehicle. The bicycle transport components, bicycle carriers, and bicycle carrier systems are easily removable from the vehicle when the vehicle owner wants to use the trunk/storage space for other things.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation.

What is claimed is:

1. A bicycle transport component for use in placing a bicycle in a vehicle, said bicycle transporting component comprising:
a member that is sized and configured to underlie one or more of surface-contacting parts of a bicycle when a bicycle is laid on its side, said member having a thickness of less than or equal to 0.4 inches, wherein said member is free from attachment to a vehicle, at least a portion of which member is substantially rigid, said member having a first side, wherein at least part of the first side is configured to at least indirectly contact a part of a bicycle that would otherwise contact the inside surface of a vehicle when a bicycle is laid on its side, and a second side for placing onto the inside surface of a vehicle, wherein said second side comprises a contact surface with a lower coefficient of friction for sliding than the bicycle would have without said transport component; and
at least one fastener having at least one proximal portion joined to the member and at least one distal portion for temporarily joining said bicycle transport component to a part of a bicycle.

2. The bicycle transport component of claim 1 wherein said member is sized and configured to underlie two or fewer of the following surface-contacting parts of a bicycle when a bicycle is laid on its side:
a. portions of the side walls and bottoms of the tires along the lower portions of the tires;
b. the rear axle;
c. a pedal;
d. the front axle; and
e. a handle bar.

3. The bicycle transport component of claim 1 wherein at least a portion of the contact surface of said second side of said member is convexly curved.

4. The bicycle transport component of claim 1 wherein at least a portion of said contact surface comprises polytetrafluorethylene.

5. The bicycle transport component of claim 1 which comprises a hub transport component comprising a first portion that is configured to be temporarily joined to the end of an axle of the wheel of a bicycle, wherein said first portion of said hub transport component has an axis that is configured to align with the axle of a bicycle wheel, and said member is joined perpendicular to the axis of said first portion, wherein said member has a circular plan view shape and has side edges that are rounded in a direction parallel to the axis to aid in sliding of the hub transport component across a surface.

6. The bicycle transport component of claim 1 which comprises a pedal transport component that is configured to be temporarily joined to a pedal of a bicycle, wherein said member is sized and configured to be placed adjacent the end of a pedal in order to cover the end of the pedal and the at least one distal portion of said at least one fastener is configured to fasten around a portion of at least one of the pedal or crank arm of a bicycle.

7. The bicycle transport component of claim 6 wherein the first side of the member of the pedal transport component has an element joined thereto extending outward from said first side, said element having a recess therein that is configured for receiving at least a portion of the end of a pedal of a bicycle.

8. The bicycle transport component of claim 1 which comprises a wheel transport component that is configured to be temporarily joined to a wheel of bicycle, wherein at least a portion of said member has a length and an arcuate shape along its length that approximates the arcuate shape of a portion of a bicycle wheel.

9. The bicycle transport component of claim 1 which comprises a handlebar transport component wherein said member has a circular plan view shape that is sized to underlie the surface-contacting parts of a bicycle handle bar, and the at least one fastener is configured to be temporarily joined to a handle bar of a bicycle.

10. The bicycle transport of claim 1 wherein said member has a length, a width, and a pair of longitudinal sides, wherein said member is sized and configured to span at least from the lowermost pedal of a bicycle laid on its side to both of the hubs of a bicycle, but not to the handlebars of a bicycle, and said bicycle transport component further comprises:
an arm having a proximal end, a distal end, and a length, wherein said arm is joined to said member so that said arm extends outward from one of the longitudinal sides of said member to a distal end; and
a second member joined to the distal end of said arm, wherein the length of said arm is sufficient to place said second member under a portion of the handlebars of a bicycle and said second member is sized and configured to underlie the portion of the handlebars of a bicycle that would otherwise contact the surface of the vehicle.

11. The bicycle transport component of claim 10 which comprises a bicycle carrier wherein said member is sized and configured to support and lift a bicycle when a bicycle is placed on the first side of the member.

12. The bicycle carrier of claim 1 wherein said at least one fastener comprises a first wheel fastener for fastening the front wheel to the member and a second wheel fastener for fastening the rear wheel to the member.

13. A bicycle carrier system for transporting two bicycles inside a vehicle, said carrier system comprising:
a first bicycle transport component according to claim 1, wherein said first bicycle transport component is configured to underlie at least parts of a first bicycle to reduce the friction when sliding a first bicycle into place on a surface inside a vehicle;
a supporting component comprising a platform that is configured to be placed inside a vehicle and overlie the first bicycle and first bicycle transport component; and
a second bicycle transport component, wherein said second bicycle transport component is configured to underlie at least parts of a second bicycle and reduce the friction in sliding a second bicycle inside a vehicle on the supporting component platform.

14. A set of components for transporting a bicycle in a vehicle, said components comprising:
a) at least one bicycle transport component comprising one or more of the following: a hub transport component, a pedal transport component, one or more wheel transport components, and a handlebar transport component; and
b) at least one immobilizing component for keeping a part of a bicycle from moving when a bicycle is placed on its side and slid across a surface, wherein said at least one immobilizing component comprises one or more of the following: a front wheel immobilizing component, a rear wheel immobilizing component, and a pedal immobilizing component.

15. A method of transporting a bicycle in a vehicle, said method comprising the steps of:
a) providing a transport component comprising:
a member, at least a portion of which member is substantially rigid, said member having a first side and a second side, wherein at least part of the first side is configured to contact a portion of a bicycle that would otherwise contact the inside surface of a vehicle when a bicycle a laid on its side, and a second side that may be placed onto the inside surface of a vehicle, wherein said second side forms a contact surface that permits said transport component with a bicycle thereon to be slid on the inside surface of a vehicle; and
at least one fastener having at least one proximal portion joined to the member and at least one distal portion for temporarily joining said bicycle transport component to a part of a bicycle;
b) bringing said transport component and a bicycle adjacent to one another by either placing said transport component on at least part of the bicycle, or by placing the bicycle on said transport component;
c) joining said bicycle transport component to a part of a bicycle using said at least one fastener;
d) lifting one end of the bicycle transport component and placing the end on the rear of a vehicle adjacent an opening into the vehicle while the other end of the bicycle transport component is on the ground;
e) lifting the other end of the transport component so that the transport component with the bicycle thereon is at least partially inside the trunk or storage space of a vehicle; and
f) sliding the bicycle transport component with the bicycle thereon so that it is positioned entirely within the trunk or storage space of a vehicle.

16. The method of claim 15 further comprising the steps of:
g) providing a supporting component comprising a platform configured to support a second bicycle in the trunk or storage space of the vehicle;
h) positioning said supporting component in the trunk or storage space of the vehicle so that said platform is above at least a portion of a first bicycle;
i) providing a second transport component comprising a member, at least a portion of which member is substantially rigid, said member having a first side and a second side, wherein at least part of the first side is configured to contact a portion of a bicycle that would otherwise contact the inside surface of a vehicle when a bicycle a laid on its side, and a second side that may be placed onto the inside surface of a vehicle, wherein said second side forms a contact surface that permits said second transport component with a bicycle thereon to be slid inside a vehicle;
j) bringing said transport component and a second bicycle adjacent to one another by either placing said transport component on at least part of the second bicycle, or by placing the second bicycle on said transport component;
k) lifting the second transport component so that the second transport component with the second bicycle thereon is at least partially in the trunk or storage space of a vehicle and at least partially resting on the platform of the supporting component; and
l) sliding the second transport component onto said platform so that the second transport component with the second bicycle thereon is positioned entirely within the trunk or storage space of a vehicle.
